(19) United States
(12) Patent Application Publication
(10) Pub. No.: US 2004/0151625 A1
(43) Pub. Date: Aug. 5, 2004

(54) Biochip apparatus device

(75) Inventors: Chi-Hsiung Hsu, Yangmei Jer Taoyuan (TW); Wu-Tsai Liao, Yangmei Jer Taoyuan (TW)

Correspondence Address: BACON & THOMAS, PLLC, 625 SLATERS LANE, FOURTH FLOOR, ALEXANDRIA, VA, 22314

(73) Assignee: SHUAI RAN PRECISION CORP., Yangmei Jer Taoyuan (TW)

(21) Appl. No.: 10/356,554

(22) Filed: Feb. 3, 2003

(51) Int. Cl. G01N 21/00

(52) U.S. Cl. 422/58

(57) ABSTRACT

The biochip apparatus device of the invention is capable of ensuring accuracy of direction and location of the sampling needle thereof regardless of whether a single or a plurality of sampling needles are being disposed. Each sampling needle thereof is provided with sampling circulation of biochemical materials for taking quantitative samples, wherein the biochemical materials, using capillarity in circulation paths as well as an XYZ triaxial servo robot, sample and array biochemical samples onto glass slides or membrane slides quantitatively and successively at a high speed for making protein, DNA or Oligo chips, thereby ensuring the sampling quantity of the biochips.

### BACKGROUND OF THE INVENTION

1. Field of the Invention

The invention relates to a biochip apparatus device, and more particularly, to a biochip apparatus device that uses biochemical materials (such as protein, DNA and Oligo) as substrates for forming sampling needles and needle holders of the biochip.

2. Description of the Related Art

Cylindrical sampling needles of contact sampling devices in prior biochips are divided into five categories, wherein the points of the sampling needles are square in shape which result square sampling in shape as well. As a result, the prior sampling needles are incapable of forming circular arrays. In addition, the prior sampling needles have the shortcomings below according different types when put to practice:

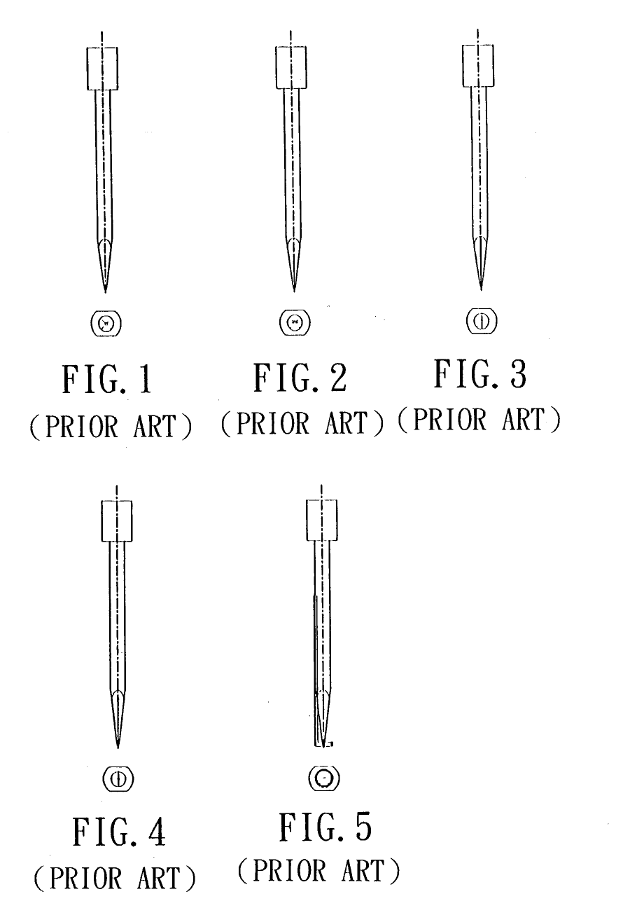

1. FIG. 1 shows a solid needle having a needlepoint made of a solid tetrahedron cone lacking design considerations of sample circulation for it is a solid structure, and therefore it is able to only take one sample at a time instead of taking samples successively; and the sampling needle is also too heavy that it damages proteins and membranes when arraying proteins on membrane slides;

2. FIG. 2 shows a solid needle having a needlepoint made of a tetrahedron cone provided with a groove for sample circulation at the cone planes;

3. FIG. 3 shows a solid needle having a needlepoint made of a tetrahedron cone provided with four grooves at the conjunctions of the cone planes;

4. FIG. 4 shows a hollow needle having a needlepoint made of a tetrahedron cone provided with a groove as that in a quill pen, although the hollow needle is capable of taking samples successively, the volumes of samples taken are yet uncontrollable due to the sample circulation design, thus resulting in samples of different sizes, and the sampling needle is also too heavy that it damages proteins and membranes when arraying proteins on membrane slides; and

5. FIG. 5 shows a needle-on-needle having a needlepoint made of a tetrahedron cone coordinating with a sampling ring-shaped tube, ring-shaped membranes are formed by dipping the ring-shaped tube into samples, and the solid needle within the ring-shaped tube is moved up and down for piercing through the ring-shaped membranes to array on glass slides or paper membrane slides; as a result, each dipping is able to take one sample at a time instead of taking samples successively, and the application of arraying proteins on membrane slides can cause damages in proteins and membranes due to the excessive weight of the sampling needle.

In addition, a cleaning device for contact sampling in a prior biochip first employs a pump to inject water circulation into a water reservoir, and uses up and down movements of an XYZ triaxial servo robot to dip the sampling needle into the water reservoir for cleaning. The drying device thereof then draws out the water drops on the sampling needle using a vacuum pump.

### SUMMARY OF THE INVENTION

The object of the invention is to provide a sampling needle developed by combining a hollow cylindrical needlepoint and a solid cylindrical guiding pillar. The end of the needlepoint thereof forms a circulation path by stamping processing for collecting and depositing samples. When the needlepoint dips into the solution of a sample, pressure difference and liquid surface tension are utilized for collecting samples of a certain quantity. Capillarity is also employed along with an XYZ triaxial servo robot and a suspension device for depositing the sample quantitatively and successively at a high speed in order to ensure the evenness of volume, color and degree of circularity of samples taken by the biochip.

### BRIEF DESCRIPTION OF THE COLLECTINGS

FIG. 1 shows a first conventional sectional view of a sampling needle of prior contact sampling biochip.

FIG. 2 shows a second conventional sectional view of a sampling needle of prior contact sampling biochip.

FIG. 3 shows a third conventional sectional view of a sampling needle of prior contact sampling biochip.

FIG. 4 shows a fourth conventional sectional view of a sampling needle of prior contact sampling biochip.

FIG. 5 shows a fifth conventional sectional view of a sampling needle of prior contact sampling biochip.

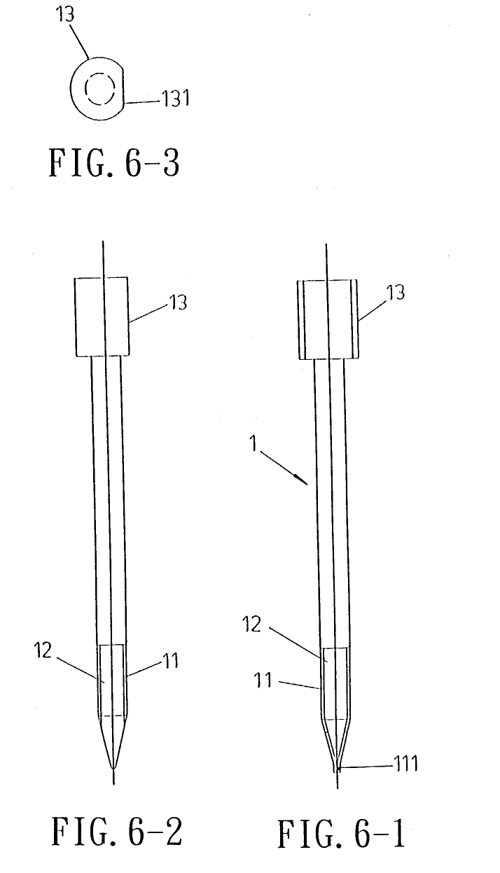

FIG. 6 shows a sectional view of the sampling needle in accordance with the invention.

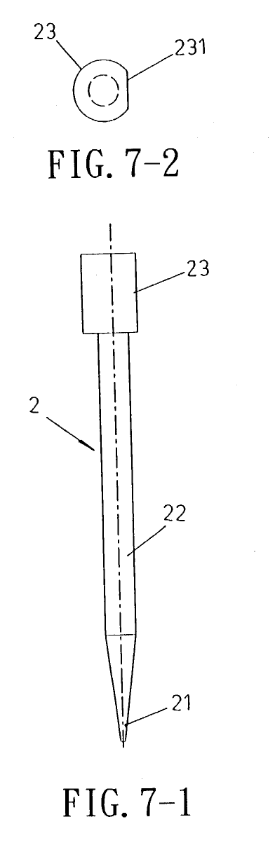

FIG. 7 shows a sectional view of the sampling needle in an embodiment in accordance with the invention.

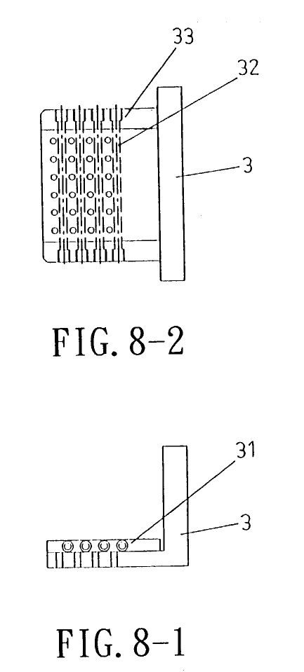

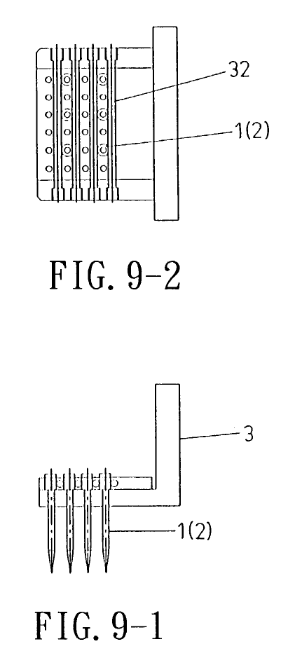

FIG. 8 shows a sectional schematic view of the needle holder in accordance with the invention.

FIG. 9 shows a sectional view of the combination of the sampling needle inserted on the needle holder in accordance with the invention.

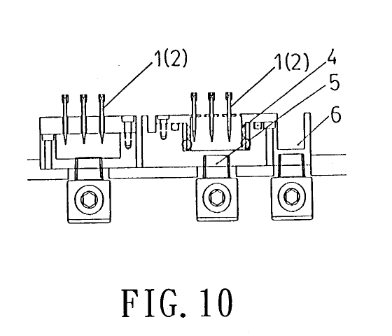

FIG. 10 shows a schematic view of the cleaning and drying devices in the sampling needle in accordance with the invention.

### DESCRIPTION OF THE PREFERRED EMBODIMENTS

Referring to FIG. 6, the sampling needle 1 in accordance with the invention comprises a hollow cylindrical needlepoint 11 combined to a solid cylindrical guiding pillar 12. The end of the needlepoint 11 thereof forms a circulation path 111 by stamping processing for collecting and depositing samples, and the sampling is round in shape. When the hollow cylindrical needlepoint 11 dips into the solution of a sample, pressure difference and liquid surface tension are utilized for collecting samples of a certain quantity. Capillarity is also employed along with an XYZ triaxial servo robot and a suspension device for depositing the sample quantitatively and successively at a high speed in order to ensure the evenness of volume, color and degree of circularity of samples taken by the biochip.

For the reason that the sampling needle 1 is a combination of the needlepoint 11 and the guiding pillar 12, the hollow needlepoint 11 may be separately combined according to the sizes of sampling. Also, the hollow needlepoint 11 may be made of stainless steel for ensuring no rusting thereof occurs that further contaminates the sample. The guiding pillar 12 may be made of stainless steel, copper or POM for increasing the sliding ability of the needle holder and the stability of the suspension device thereof.

Referring to FIG. 7 showing another embodiment in accordance with the invention, the sampling needle 2 comprises a solid cylindrical needlepoint 21 combined to a solid cylindrical guiding pillar 22. The end of the needlepoint 21 is processed by lathing or grinding for collecting and depositing samples with a circular sampling shape. Samples are depositd successively at a high speed using the XYZ triaxial servo robot and the suspension device for ensuring that the evenness of volume, color and degree of circularity of samples taken by the biochip.

Referring to FIGS. 6-3 and 7-2, the bases 13 and 23 of the guiding pillars 12 and 22 of the invention are processed by conventional milling for removing a corner 131 and 231, respectively, such that errors in sampling arrays are not resulted in the sampling needles 1 and 2 from rotation and processing errors.

Referring to FIG. 8, the needle holder 3 is made of aluminum or copper, and the upper rim 31 thereof is processed by conventional drilling, milling or shearing to form a plurality of vertical stop posts 32 disposed on two supporting frames 33 for restraining the sampling needles 1 and 2 from rotating. Referring to FIG. 9 showing the combination of the sampling needles 1 and 2 inserted on the needle holder 3, owing to the stop posts 32 provided, the accuracy of direction and location of the sampling 1 is also made certain regardless of disposing a single or a plurality of sampling needles 1 and 2.

Referring to FIG. 10, the cleaning and drying device in the contact sampling biochip in accordance with the invention uses a high-pressure pump to inject the water circulation into the peripheric nozzles 4 at the upper rim of the water reservoir, and high-pressure water columns are employed along with the up and down movements of the XYZ triaxial servo robot to dip the sampling needles 1 and 2 for cleaning. Water is then discharged through a water discharging opening 5 at the bottom of the water reservoir and an overflowing opening 6 at the upper rim thereof.

The drying device is formed by injecting air into the peripheric nozzle 4 using a vacuum pump for quickly drying the mist of the sampling needles 1 and 2.

It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A biochip apparatus device, wherein the sampling needle thereof is formed by combining a hollow cylindrical needlepoint to a solid cylindrical guiding pillar; the end of the needlepoint forms a circulation path using stamping process for collecting and depositing samples; when the hollow cylindrical needlepoint dips into the solution of a sample, pressure difference and liquid surface tension are utilized for collecting the sample at a certain quantity; and the XYZ triaxial servo robot and a suspension device are also utilized for depositing the sample quantitatively and successively at a high speed.

2. The biochip apparatus device according to claim 1, wherein milling process is used for removing a corner of the base of the guiding pillar of the sampling needle for accommodating the base, such that errors in sampling arrays are not resulted in the sampling needle from rotation and processing errors.

3. The needle holder according to claim 2, wherein the upper rim thereof is processed for forming a plurality of vertical stop posts disposed on two supporting frames for restraining the sampling needle from rotating.

4. The biochip apparatus device according to claim 1, wherein a cleaning device in the sampling needle is formed by injecting water circulation into a peripheric nozzle at the upper rim of a water reservoir using a high-pressure vacuum pump, and the high-pressure water columns along with up and down movements of the XYZ triaxial servo robot are employed to dip the sampling needle into the water reservoir for cleaning.

5. The biochip apparatus device according to claim 1, wherein a drying device in the sampling needle is formed by injecting air into the peripheric nozzle by a high-pressure vacuum pump and high-pressure air for quickly drying the mist of the sampling needle.
